(19) United States
(12) Patent Application Publication
(10) Pub. No.: US 2007/0214989 A1
(43) Pub. Date: Sep. 20, 2007

(54) Highly Fadeproof Inks Used for Digital Textile Printing

(75) Inventors: Markus Arnold, Kelsterbach (DE); Mathias Muth, Wiesbaden (DE)

Correspondence Address: CONNOLLY BOVE LODGE & HUTZ, LLP, P O BOX 2207, WILMINGTON, DE, 19899, US

(73) Assignee: DyStar Textilfarben Gmbh & Co. Deutschland KG, Frankfurt am Main (DE)

(21) Appl. No.: 10/594,137

(22) PCT Filed: Mar. 22, 2005
(86) PCT No.: PCT/EP05/03016

§ 371 Date: Oct. 18, 2006

(30) Foreign Application Priority Data
Apr. 2, 2004 (DE) 10 2004 016 287.5

(51) Int. Cl. C09B 57/04; C09D 11/00; D06P 5/30

(52) U.S. Cl. 101/483; 106/31.49; 548/159

(57) ABSTRACT

Aqueous printing inks for textile printing by the inkjet process, comprising one or more dyes of the formula (I) 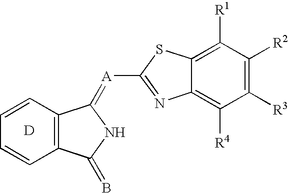
in which A, B, R¹ to R⁶ and D are as defined in claim 1, processes for preparing them and their use for textile printing by the inkjet process.

Digital printing techniques will become increasingly important in the future both in the textile segment and in the nontextile segment.

The altered market requirements in conventional textile printing call for more flexibility in design, color, and delivery time. One response to this development is digital inkjet technology. By making it possible to print directly from the computer via the printing nozzles onto the textiles without the need to prepare printing screens, this new technology is improving printing process flexibility, efficiency, and environmental compatibility. It allows substantially integrated operations, shortens printing times, and meets the demand for rapid reaction to market developments and for fewer intermediate stages in the manufacturing operation.

The inkjet process normally uses aqueous inks which are sprayed as small droplets directly onto the substrate. There is a division between a continuous flow process, in which ink droplets are generated without interruption and guided onto the substrate through an electrical field, as a function of the pattern to be printed, and an interrupted inkjet or drop-on-demand process, in which the ink is ejected only where a colored dot is to be placed. The latter process employs either a piezoelectric crystal or a heating element (bubblejet or thermal jet process) to exert pressure on the ink system and so to force out a drop of ink. Such procedures are described in Text. Chem. Color, Volume 19 (8), pages 23 ff and Volume 21 pages 27 ff. Other drop-on-demand processes include the “flatjet process”, which is described for example in WO 99/46126, where piezoelectrically controlled vibration of a dye-filled needle forces ink droplets onto the substrate, and the “valvejet process” in which the inkjet and hence the pixel distribution is regulated via a valve, a process of this kind being described for example in U.S. Pat. No. 4,555,719.

This highly sensitive microtechnology requires the development of tailor-made dye preparations (inks) which meet, for example, the exacting requirements in terms of purity, particle size, viscosity, surface tension, conductivity, physicochemical stability, thermophysical properties, pH, absence of foam and microfoam, color strength, fastness level, and storage stability. Commercially customary textile dyes in the form of their powder, granule or liquid formulations, as are used for conventional analog textile printing, contain significant amounts of electrolyte, deduster and standardizer, which lead to massive problems in inkjet printing. Moreover, dye inks, such as are used for nontextile materials, such as paper, wood, plastics, ceramic, etc., for example, give only unsatisfactory results in terms of application properties and also color yield and print fastnesses on textile material.

Inkjet inks based on disperse dyes have a number of performance deficiencies which relate to the dispersion stability of the inks and the fastnesses achieved in printing, especially the lightfastness of the resultant prints.

It was an object of the present invention, therefore, to provide printing inks which do not have the abovementioned disadvantages.

It has now surprisingly been found that inks based on isoindolenine dyes, such as are known from EP 684 289, provide outstanding results.

The present invention accordingly provides new aqueous printing inks for textile printing by the inkjet process, which comprise an isoindolenine dye of the formula (I) 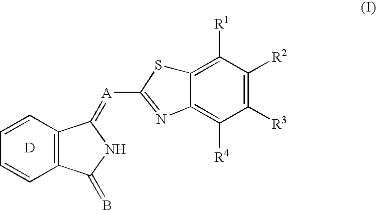
in which
A is N or a cyanomethylene radical,
B is a radical of the formula C(CN)COOR⁵ or N—R⁶,
R¹ to R⁴ independently of one another are hydrogen, halogen, unsubstituted or substituted C₁-C₈ alkyl or C₅-C₆ cycloalkyl, uninterrupted or oxygen-interrupted C₁-C₁₀ alkoxy, unsubstituted or substituted C₆-C₁₀ aryloxy, CF₃, or unsubstituted or substituted dialkylamine, or pairs of adjacent R¹ to R⁴ radicals together with the aromatic ring carbon atoms form a fused benzene or naphthalene ring, which where appropriate may be substituted further, examples of possible substituents including halogen or C₁-C₄ alkyl,
R⁵ is an unsubstituted or substituted and uninterrupted or oxygen-interrupted, saturated or unsaturated C₁-C₂₀ alkyl radical, C₆-C₁₀ aryl C₁-C₁₀ alkyl or hetarylalkyl,
R⁶ is unsubstituted or substituted and uninterrupted or oxygen-interrupted C₁-C₂₀ alkyl, cycloalkyl, cycloalkylalkyl or aralkyl, and the ring D is unsubstituted or carries at least one substituent which where appropriate, together with a further substituent in ortho position and the ring carbon atoms, forms a fused benzene or naphthalene ring. Examples of suitable radicals R¹ to R⁴ include the following: hydrogen, chloro, bromo, methyl, ethyl, isopropyl, tert-butyl, methoxy, ethoxy, n-propoxy, n-butoxy, methoxyethyl, methoxyethoxyethyl, ethoxyethyl, ethoxyethoxyethyl, butoxyethyl, phenoxy, 2-methylphenoxy, 3-methylphenoxy, 4-methylphenoxy, dimethylamino, diethylamino and bis-(2-cyanoethyl)amino.

Examples of suitable radicals R⁵ include the following: methyl, ethyl, n-propyl, isopropyl, allyl, n-butyl, n-pentyl, n-hexyl, n-heptyl, n-octyl, n-decyl, 2-methoxyethyl, 2-ethoxyethyl, 2-isopropoxyethyl, 2-butoxyethyl, 2-allyloxyethyl, 2-(2-methoxyethoxy)ethyl, 2-(2-ethoxyethoxy)ethyl, 2-(2-methoxyethoxy)ethyl, 2-cyanoethyl, 2-(cyanoethoxy)ethyl, 4-(2-cyanoethoxy)butyl, 2-ethylhexyl, benzyl, phenylethyl. 3-phenylpropyl, phenoxyethyl and furfuryl. Suitable branched radicals R⁵ include preferably those having a methyl side chain, such as: isobutyl, tert-butyl, isopentyl, 1-methoxy-2-propanol and 1-ethoxy-2-propanol.

Examples of suitable radicals R⁶ include the following: methyl, ethyl, n-propyl, isopropyl, allyl, n-butyl, n-pentyl, n-hexyl, n-heptyl, n-octyl, n-decyl, 2-ethylhexyl, 2-methoxyethyl, 2-ethoxyethyl, 3-methoxypropyl, 3-ethoxypropyl, 3-butoxypropyl, 3-phenoxypropyl, 3-(2-phenoxyethoxy)-propyl, cyclohexyl, cyclohexylmethyl, benzyl and 2-phenylethyl.

Preferred dyes of the formula (I) are those in which R¹ and R² independently of one another are hydrogen, Cl, Br, methyl, ethyl, n-propyl, isopropyl, n-butyl, isobutyl, tert-butyl, cyclohexyl, uninterrupted C₁-C₁₀ alkoxy or C₁-C₁₀ alkoxy interrupted by 1 to 2 oxygens; unsubstituted or substituted phenoxy, CF₃ or a di(C₁-C₄)-alkylamino group, R³ and R⁴ have the definition of R¹ and R² or together with the ring carbon atoms form a fused benzene ring, R⁵ is a C₁-C₁₂ alkyl which is unsubstituted or substituted by Cl, by CN or by unsubstituted or substituted phenoxy and is uninterrupted or interrupted by 1 to 2 oxygen atoms, or is C₆-C₁₀ aryl-C₁-C₁₀ alkyl or hetarylalkyl, R⁶ is a saturated or unsaturated C₁-C₁₂ alkyl which is unsubstituted or substituted by unsubstituted or substituted phenoxy and is uninterrupted or interrupted by 1 to 2 oxygens, and the ring D is unsubstituted or substituted by CN, halogen atoms, in particular 1 to 4 Cl atoms, 1 to 2 C₁-C₁₀ alkyl radicals and/or 1 to 2 C₁-C₁₀ alkoxy radicals, or an unsubstituted or substituted phenyl radical. In particular, however, the ring D is unsubstituted.

Particularly preferred dyes of the formula (I) are those of the formula (II) 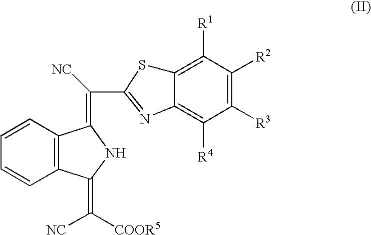
in which R¹ to R⁵ are as defined above, R¹ to R⁴ independently of one another preferably being hydrogen, chloro, methyl, ethyl, isopropyl, tert-butyl, cyclohexyl, methoxy, ethoxy, n-propoxy, n-butoxy, methoxyethyl, ethoxyethyl, butoxyethyl or phenoxy and R⁵ preferably being n-butyl, isobutyl, n- or isopentyl, hexyl, octyl, 2-ethylhexyl, methoxyethyl, ethoxyethyl, butoxyethyl, butoxyethoxyethyl.

Further preference is given to dyes of the formula (I) that conform to the formula (III) 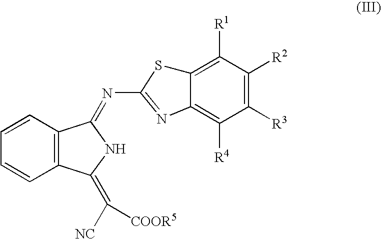
in which R¹ to R⁵ are as defined above, R¹ to R⁴ independently of one another preferably being hydrogen, chloro, methyl, ethyl, isopropyl, tert-butyl, cyclohexyl, methoxy, ethoxy, n-propoxy, n-butoxy, methoxyethyl, ethoxyethyl, butoxyethyl or phenoxy and

R⁵ preferably being methyl, ethyl, propyl, isopropyl, allyl, n-butyl, isobutyl, n- or isopentyl, hexyl, octyl, 2-ethylhexyl, methoxyethyl, ethoxyethyl, butoxyethyl or butoxyethoxyethyl.

Likewise preferred are dyes of the formula (I) that conform the formula (IV) 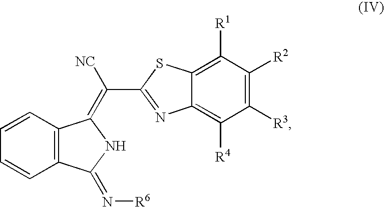
in which R¹ to R⁴ and R⁶ are as defined above, R¹ to R⁴ independently of one another preferably being hydrogen, chloro, methyl, isopropyl, tert-butyl, cyclohexyl, methoxy, ethoxy, n-propoxy, n-butoxy, methoxyethyl, ethoxyethyl, butoxyethyl or phenoxy and

R⁶ preferably being methyl, ethyl, propyl, isopropyl, allyl, n-butyl, isobutyl, n- or isopentyl, hexyl, octyl, 2-ethylhexyl, cyclohexyl, methoxypropyl, ethoxypropyl, 2-phenoxyethyl, 3-phenoxypropyl, 2-phenoxyethoxypropyl, phenylethyl.

Preference is given, moreover, to dyes of the formula (I) that conform to the formula (V) 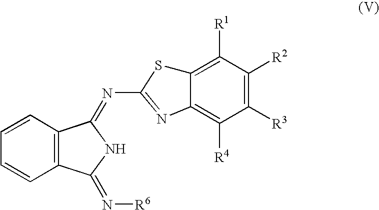
in which

R¹ to R⁴ and R⁶ are as defined above,

R¹ to R⁴ independently of one another preferably being hydrogen, chloro, methyl, isopropyl, tert-butyl, cyclohexyl, methoxy, ethoxy, n-propoxy, n-butoxy, methoxyethyl, ethoxyethyl, butoxyethyl or phenoxy and

R⁶ preferably being methyl, ethyl, propyl, isopropyl, allyl, n-butyl, isobutyl, n- or isopentyl, hexyl, octyl, 2-ethylhexyl, cyclohexyl, methoxypropyl, ethoxypropyl, 2-phenoxyethyl, 3-phenoxypropyl, 2-phenoxyethoxypropyl, phenylethyl.

Besides the dye the printing inks contain 0.1% to 20% of dispersants. Examples of suitable dispersants include sulfonated and sulfomethylated lignins, formaldehyde condensates of aromatic sulfonic acids, formaldehyde condensates of unsubstituted or substituted phenol derivatives, polyacrylates and their copolymers, polyethers containing styrene oxide, modified polyurethanes, reaction products of alkylene oxides with alkylatable compounds such as, for example, fatty alcohols, fatty amines, fatty acids, carboxamides, resin acids and also unsubstituted or substituted phenols.

For the inks to be used in the continuous flow process a conductivity of 0.5 to 25 mS/cm can be set by adding electrolyte. Examples of suitable electrolytes include the following: lithium nitrate or potassium nitrate. The dye inks of the invention may include organic solvents with a total content of 1-60%, preferably of 5-40% by weight. Examples of suitable organic solvents are alcohols, e.g., methanol, ethanol, 1-propanol, 2-propanol, 1-butanol, tert-butanol, 1-pentanol, benzyl alcohol, 2-butoxyethanol, 2-(2-methoxyethoxy)ethanol, 2-(2-ethoxyethoxy)ethanol, 2-(2-butoxyethoxy)ethanol, 2-(2-propoxyethoxy)ethanol;

polyhydric alcohols, e.g.: 1,2-ethanediol, 1,2,3-propanetriol, 1,2-butanediol, 1,3-butanediol, 1,4-butanediol, 1,2-propanediol, 1,3-propanediol, 1,2-pentanediol, 1,3-pentanediol, 1,4-pentanediol, 1,5-pentanediol, 1,2-hexanediol, 1,6-hexanediol, 1,2,6-hexanetriol, 1,2-octanediol, trimethylolethane, trimethylolpropane;

polyalkylene alcohols, e.g.: polyethylene glycol and polypropylene glycol and their copolymers, alkylene glycols having 2 to 8 alkylene groups and also corresponding thioether compounds, e.g.: monoethylene glycol, diethylene glycol, triethylene glycol, tetraethylene glycol, thioglycol, thiodiglycol, butyl diglycol, butyl triglycol, hexylene glycol, propylene glycol, dipropylene glycol, tripropylene glycol; lower alkyl ethers of polyhydric alcohols, e.g.: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, polyalkylene glycol ethers, such as: polyethylene glycol monomethyl ether, polypropylene glycol glycerol ether, polyethylene glycol tridecyl ether, polyethylene glycol nonylphenyl ether;

amines, such as: methylamine, ethylamine, triethylamine, diethylamine, dimethylamine, trimethylamine, dibutylamine, diethanolamine, triethanolamine, N-acetylethanolamine, N-formylethanolamine, ethylenediamine, urea derivatives, such as: urea, thiourea, N-methylurea, N,N′-epsilon-dimethylurea, ethyleneurea, 1,1,3,3-tetramethylurea;

amides, such as: dimethylformamide, dimethylacetamide, acetamide;

ketones or keto alcohols, such as: acetone, diacetone alcohol;

cyclic ethers, such as: tetrahydrofuran, gamma-butyrolactone, epsilon-caprolactam;

and also sulfolane, dimethylsulfolane, methylsulfolane, 2,4-dimethylsulfolane, dimethyl sulfone, butadiene sulfone, dimethyl sulfoxide, dibutyl sulfoxide, N-cyclohexylpyrrolidone, N-methyl-2-pyrrolidone, N-ethyl-pyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, pyridine, piperidine, butyrolactone, ethylenediaminetetraacetate.

The printing inks of the invention may further include the customary additives, such as, for example, viscosity moderators to set viscosities in the range from 1 to 40.0 mPa.s in a temperature range from 20 to 50° C. Preferred inks have a viscosity of 1 to 20 mPa.s and particularly preferred inks a viscosity of 1 to 15 mPa.s.

Suitable viscosity moderators include rheological additives, examples including the following: polyvinylcaprolactam or polyvinylpyrrolidone and their copolymers, polyetherpolyol, associated thickeners, polyurea, polyurethane, sodium alginates, modified glactomannans, polyetherurea, polyurethane and nonionic cellulose ethers.

As further additions, the inks of the invention may include surface-active substances to set surface tensions of 20 to 65 mN/m, which are adapted where appropriate as a function of the process being used (thermal or piezo technology).

Examples of suitable surface-active substances include the following: ionic and nonionic surfactants.

For the purpose of enhancing the lightfastness the inks may further comprise UV absorbers. Suitable examples include unsubstituted or substituted benzophenones, unsubstituted or substituted benzotriazoles, unsubstituted or substituted benzotriazines and also UV stabilizers based on sterically hindered amines (HALS type).

The inks may also include customary additions, such as substances for inhibiting fungal and bacterial growth, for example, and/or defoamers such as polyethersiloxane copolymers or organically modified polysiloxanes, for example.

The inks can be prepared in conventional manner by comminuting the corresponding dye in the presence of one or more dispersants and water in a milling apparatus. The other ink constituents may be added before, during or after the milling operation. Particularly suitable milling apparatus includes agitated ball mills in which beads are used with a diameter of 0.05 mm to 2.0 mm, preferably smaller than 1.0 mm. For the milling operation it is preferred to prepare a relatively concentrated ink paste which following the milling process is diluted further to give the end composition. The ink obtained in this way can either be used directly or subjected to further purification (filtration, for example) or the milling process can be continued by further treatment in the milling apparatus.

The dye inks of the invention are useful in inkjet printing processes for printing a wide variety of untreated or pretreated polyester, polyamide, acetate, triacetate or polyurethane materials, especially polyester materials. The printing inks of the invention are also suitable for printing the aforementioned fibers in blend fabrics, such as blends of cotton and polyester, for example.

The textile substrate is pretreated prior to printing with thickeners, which prevent the motifs running when the printing ink is applied; examples of such thickeners include sodium alginates, modified polyacrylates or highly etherified galactomannans; and/or with substances which increase the fixing yield.

These pretreatment reagents are applied uniformly to the textile substrate in a defined amount using suitable applicators, such as with a 2- or 3-roll padder, for example, with contactless spray technologies, by means of foam application, or with appropriately adapted inkjet technologies, and then dried.

After the textile fiber material has been printed it can be dried at 80 to 150° C. and/or subsequently fixed. The fixing of the inkjet prints prepared with disperse dyes takes place at elevated temperature, using saturated steam, using superheated steam, using hot air, using compressed steam, using microwaves, using infrared radiation, using laser or electron beams, or using other suitable energy transfer techniques.

Fixing may be followed by a print aftertreatment, which leads to an improvement in fastness properties and also to an immaculate white ground.

Particularly on synthetic fiber materials the prints prepared with the dye inks of the invention possess high color strength, good cold and hot lightfastness, very good wetfastness properties, such as fastness to washing, water, saltwater, weather fastness and perspiration fastness, and also good fastness to heat setting and pleating, and crock fastness.

The examples which follow serve to illustrate the invention. Parts and percentages are by weight unless otherwise noted. The relationship between parts by weight and parts by volume is that of the kilogram to the liter.

General Procedure:

Preparation of an ink paste (containing 25% of dye): 125 g of dye are combined together with X weight equivalents (1 weight equivalent corresponds to 125 g) of dispersant/dispersant mixture and 375-125X g of demineralized water and the mixture is milled in an agitated ball mill so that the mean particle size is <250 nm and the maximum particle size is smaller than 1 μm. It is possible for further additives such as biocides, defoamers, etc. and also parts of the organic solvents used to be added even at the ink paste milling stage.

The other constituents of the ink (organic solvents, other additives, water) are added to the ink paste thus prepared (containing 25% of dye) and the components are combined thoroughly by beating in a dissolver. Once they have been filtered through a standard commercial filter paper (Macherey-Nagel MN-614) the inks are ready for use.

### EXAMPLE 1

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
3.5% of the dye (1) 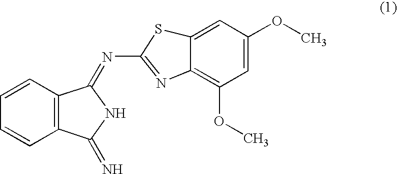
2.5% of dispersant Disperbyk 190
30% of 1,5-pentanediol
5% of diethylene glycol monomethyl ether
0.01% of biocide Mergal K9N
58.99% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried.

### EXAMPLE 2

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
2% of the dye (2) 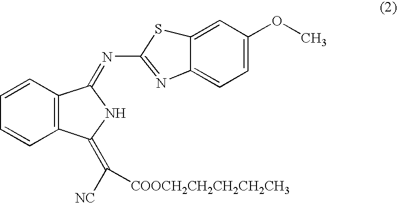
1% of dispersant Tego Dispers 740 W
20% of glycerol
0.01% of biocide Mergal K9N
76.99% of water
   using a drop-on-demand (bubblejet) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 3

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
7% of the dye (2)
3% of dispersant Tamol
30% of diethylene glycol
0.01% of biocide Mergal K9N
59.99% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 4

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
1% of the dye (2)
0.6% of dispersant Tego Dispers 760 W
15% of polyethylene glycol 400
0.01% of biocide Mergal K9N
83.39% of water
   using a drop-on-demand (bubblejet) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 5

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
5% of the dye (2)
2% of dispersant Ultrazine NA (ligninsulfonate, borregaard)
15% of polyethylene glycol 400
0.01% of biocide Mergal K9N
77.99% of water
   using a drop-on-demand (piezo) inkjet printing head. The print is fully dried. Fixing takes place by means of superheated steam at 1 75° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 6

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
4% of the dye (2)
1% of dispersant Ultrazine NA (ligninsulfonate, borregaard)
1% of dispersant Tego Dispers 650
0.01% of biocide Mergal K9N
83.99% of water
   using a drop-on-demand (flatjet) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 7

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
3% of the dye (3) 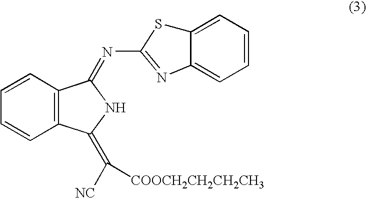
3% of dispersant Disperbyk 190
10% of polyethylene glycol 400
20% of polypropylene glycol
0.01% of biocide Mergal K9N
63.99% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 8

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
9% of the dye (3)
3% of dispersant Tego Dispers 740 W
5% of polyethylene glycol 200
10% of ethylene glycol
0.01% of biocide Mergal K9N
72.99% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 9

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
5% of the dye (4) 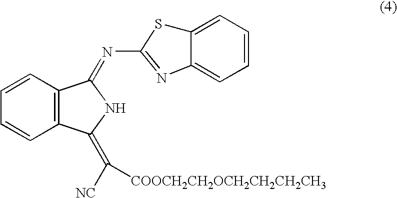
5% of dispersant Tamol
10% of 1,2-hexanediol
20% of N-methylpyrrolidone
0.01% of biocide Mergal K9N
59.99% of water
   using a drop-on-demand (bubblejet) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 10

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
2% of the dye (3)
2% of the dye (4)
2% of dispersant Ultrazine NA (ligninsulfonate, borregaard)
10% of diethylene glycol
20% of sulfolane
2% of urea
0.01% of biocide Mergal K9N
61.99% of water
   using a drop-on-demand (bubblejet) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 11

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
1.5% of the dye (3)
2.5% of the dye (4)
2% of dispersant Tego Dispers 760 W
0.5% of dispersant Tego Dispers 650
20% of glycerol
5% of diethylene glycol
0.2% of Surfynol 104 E (Air Products)
0.01% of biocide Mergal K9N
68.29% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried. This gives a yellow-orange print of high brightness having an outstanding durability and hot lightfastness properties.

### EXAMPLE 12

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
3% of the dye (5) 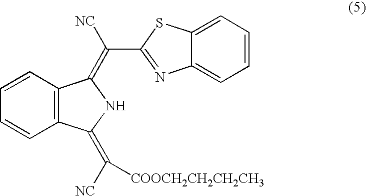
2% of dispersant Ultrazine NA (ligninsulfonate, borregaard)
15% of propylene glycol
5% of polyethylene glycol 800
0.01% of biocide Mergal K9N
74.99% of water
   using a drop-on-demand (valvejet) inkjet printing head. The print is fully dried. Fixing takes place by means of superheated steam at 175° C. for 7 minutes. The print is then subjected to an alkalinically reductive aftertreatment, rinsed warm and then dried. This gives a yellow, fluorescent print of high brightness having an outstanding durability and hot lightfastness properties.

### EXAMPLE 13

A textile fabric consisting of polyester is padded with a liquor consisting of 50 g/l of an 8% strength sodium alginate solution, 100 g/l of an 8-12% strength bean gum ether solution and 5 g/l of monosodium phosphate in water and then dried. The liquor pickup is 70%. The textile thus pretreated is then printed with an aqueous ink prepared in accordance with the procedure described above and containing
6% of the dye (6) 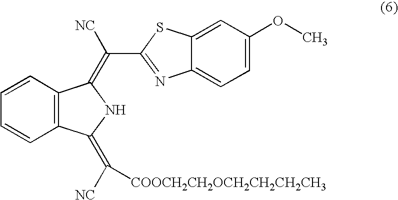
1.5% of dispersant Disperbyk 190
10% of 2-propanol
20% of polyethylene glycol 200
0.01% of biocide Mergal K9N
62.49% of water
   using a drop-on-demand (piezo) inkjet printing head. The print is fully dried. Fixing takes place by means of superheated steam at 175° C. for 7 minutes. The print is then subjected to an alkalinically reductive aftertreatment, rinsed warm and then dried. This gives an orange print of high brightness having an outstanding durability and hot lightfastness properties.

1. An aqueous printing ink for textile printing by the inkjet process, comprising one or more dyes of the formula (I) 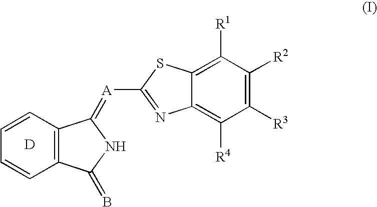
in which
A is N or a cyanomethylene radical,
B is a radical of the formula C(CN)COOR⁵ or N—R⁶,
R¹ to R⁴ independently of one another are hydrogen, halogen, unsubstituted or substituted C₁-C₈ alkyl or C₅-C₆ cycloalkyl, uninterrupted or oxygen-interrupted C₁-C₁₀ alkoxy, unsubstituted or substituted C₆-C₁₀ aryloxy, CF₃, or unsubstituted or substituted dialkylamine, or pairs of adjacent R¹ to R⁴ radicals together with the aromatic ring carbon atoms form a fused benzene or naphthalene ring, which where appropriate is substituted further,
R⁵ is an unsubstituted or substituted and uninterrupted or oxygen-interrupted, saturated or unsaturated C₁-C₂₀ alkyl radical, C₆-C₁₀ aryl C₁-C₁₀ alkyl or hetarylalkyl, R⁶ is unsubstituted or substituted and uninterrupted or oxygen-interrupted C₁-C₂₀ alkyl, cycloalkyl, cycloalkylalkyl or aralkyl, and
the ring D is unsubstituted or carries at least one substituent which where appropriate, together with a further substituent in ortho position and the ring carbon atoms, forms a fused benzene or naphthalene ring.

2. An aqueous printing ink for textile printing by the inkjet process, comprising dyes of the formula (I) as set forth in claim 1, in which
R¹ and R² independently of one another are hydrogen, Cl, Br, methyl, ethyl, n-propyl, isopropyl, n-butyl, isobutyl, tert-butyl, cyclohexyl, uninterrupted C₁-C₁₀ alkoxy or C₁-C₁₀ alkoxy interrupted by 1 to 2 oxygens; unsubstituted or substituted phenoxy, CF₃ or a di(C₁-C₄)-alkylamino group,
R³ and R⁴ have the definition of R¹ and R² or together with the ring carbon atoms form a fused benzene ring,
R⁵ is a C₁-C₁₂ alkyl which is unsubstituted or substituted by Cl, by CN or by unsubstituted or substituted phenoxy and is uninterrupted or interrupted by 1 to 2 oxygen atoms, or is C₆-C₁₀ aryl-C₁-C₁₀ alkyl or hetarylalkyl,
R⁶ is a saturated or unsaturated C₁-C₁₂ alkyl which is unsubstituted or substituted by unsubstituted or substituted phenoxy and is uninterrupted or interrupted by 1 to 2 oxygens, and
ring D is unsubstituted or substituted by CN, halogen atoms, 1 to 2 C₁-C₁₀ alkyl radicals and/or 1 to 2 C₁-C₁₀ alkoxy radicals, or a phenyl radical, which are each uninterrupted or interrupted by 1 to 2 oxygen atoms.

3. An aqueous printing ink for textile printing by the inkjet process, comprising dyes as set forth in claim 1 of the formula (II) 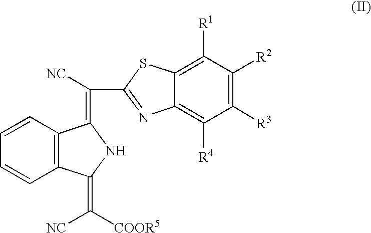
in which R¹ to R⁵ are as defined in claim 1.

4. An aqueous printing ink for textile printing by the inkjet process, comprising dyes as set forth in claim 1 of the formula (III) 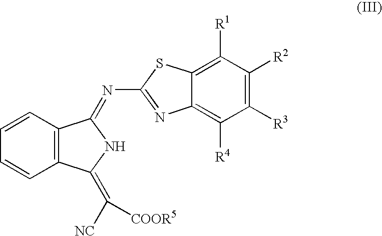
in which R¹ to R⁵ are as defined in claim 1.

5. An aqueous printing ink for textile printing by the inkjet process, comprising dyes as set forth in claim 1 of the formula (IV) 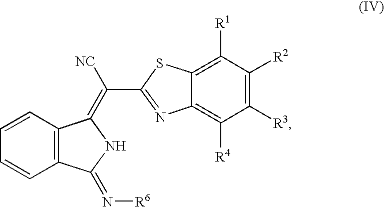
in which R¹ to R⁴ and R⁶ are as defined in claim 1.

6. An aqueous printing ink for textile printing by the inkjet process, comprising dyes as set forth in claim 1 of the formula (V) 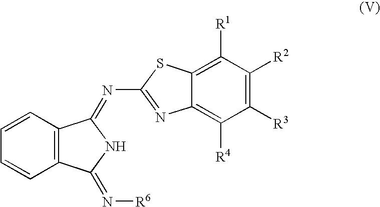
in which R¹ to R⁴ and R⁶ are as defined in claim 1.

7. An aqueous printing ink for textile printing by the inkjet process as claimed in claim 1, comprising one or more disperse dyes of the formula (I) in amounts of 0.01% by weight to 40% by weight, based on the total weight of the ink.

8. An aqueous printing ink for textile printing by the inkjet process as claimed in claim 1, containing 0.1%-20% by weight of a dispersant and also 1% to 60% of organic solvents, based on the total weight of the ink.

9. A method of printing textile fiber materials by the inkjet process, which comprises employing a printing ink as claimed in claim 1.

10. The aqueous printing ink ring D is unsubstituted or substituted by CN, 1 to 4 Cl atoms, 1 to 2 C₁-C₁₀ alkyl radicals and/or 1 to 2 C₁-C₁₀ alkoxy radicals, or a phenyl radical, which are each uninterrupted or interrupted by 1 to 2 oxygen atoms.

11. The aqueous printing ink for textile printing by the inkjet process as claimed in claim 3, comprising one or more disperse dyes of the formula (I) in amounts of 0.01% by weight to 40% by weight, based on the total weight of the ink.

12. The aqueous printing ink for textile printing by the inkjet process as claimed in claim 11, containing 0.1%-20% by weight of a dispersant and also 1% to 60% of organic solvents, based on the total weight of the ink.

13. The aqueous printing ink for textile printing by the inkjet process as claimed in claim 4, comprising one or more disperse dyes of the formula (I) in amounts of 0.01% by weight to 40% by weight, based on the total weight of the ink.

14. The aqueous printing ink for textile printing by the inkjet process as claimed in claim 13, containing 0.1%-20% by weight of a dispersant and also 1% to 60% of organic solvents, based on the total weight of the ink.

15. The aqueous printing ink for textile printing by the inkjet process as claimed in claim 5, comprising one or more disperse dyes of the formula (I) in amounts of 0.01% by weight to 40% by weight, based on the total weight of the ink.

16. The aqueous printing ink for textile printing by the inkjet process as claimed in claim 15, containing 0.1%-20% by weight of a dispersant and also 1% to 60% of organic solvents, based on the total weight of the ink.

17. The aqueous printing ink for textile printing by the inkjet process as claimed in claim 6, comprising one or more disperse dyes of the formula (I) in amounts of 0.01% by weight to 40% by weight, based on the total weight of the ink.

18. The aqueous printing ink for textile printing by the inkjet process as claimed in claim 17, containing 0.1%-20% by weight of a dispersant and also 1% to 60% of organic solvents, based on the total weight of the ink.
